(19) United States
(12) Patent Application Publication
(10) Pub. No.: US 2011/0077876 A1
(43) Pub. Date: Mar. 31, 2011

(54) TAP FOR MOUNTING ON CONTAINER FOR FLUID AND METHOD FOR REGISTERING THE LEVEL OF FLUID IN SAID CONTAINER

(75) Inventors: Bjarte Sorebo Ellingsen, Oslo (NO); Olav Ellingsen, Floro (NO)

(73) Assignee: MULTISENSE AS, OSLO (NO)

(21) Appl. No.: 12/990,461

(22) PCT Filed: Apr. 30, 2009
(86) PCT No.: PCT/NO09/00168

§ 371 Date: Nov. 18, 2010

(30) Foreign Application Priority Data
Apr. 30, 2008 (NO) 20082066
Sep. 1, 2008 (NO) 20083752

(51) Int. Cl. G01F 23/14

(52) U.S. Cl. 702/55

(57) ABSTRACT

The present invention relates to a tap for mounting on a container containing liquid, such as a wine box, a container containing medicine or a chemical, which tap comprises a sensor arranged on or in the tap for determining the outflow of liquid as a function of dispensing time and outflow characteristics. A display indicates the remaining amount of liquid in the container.

The present invention relates to a tap for mounting on a container containing liquid and a method for detecting the liquid level in such a container.

The present invention could be used on a number of different containers containing different liquids. In the following, however, the invention will be described with a main emphasis on wine boxes as an example.

It should also be noted that the tap would be highly suitable for mounting on a container containing, for example, medicine and also on containers containing different types of chemicals.

Today there exists a wide variety of cardboard containers with an inner bag of plastic or similar material containing some form of liquid. One instance of this is wine in BIBs (Bag in Box) of various sizes. A BIB consists of a carton of cardboard or similar material with a bag of plastic or similar material arranged therein which contains the actual wine. A typical size of a bag in box is three litres.

BIBs have become very popular, partly because the wine keeps well even after it has started to be dispensed. This is because the bag in the box that contains the wine collapses as the wine is dispensed without allowing any air to enter, which is what happens when wine is poured from a bottle. If the wine comes into contact with air for a longish period of time, the air spoils the wine as the wine becomes oxidised.

One disadvantage of “box wine” is, however, that it is not easy to see how much is left in the carton and it is therefore less easy to check on what has been consumed. In addition, it is not possible to measure the temperature of the wine in a conventional manner, which is highly desirable in order to be able to serve the wine at the right temperature.

The object of the present invention is to teach a way of measuring the level and the temperature in containers containing liquid or liquid-like substances where known methods of level measurement and temperature measurement cannot directly be used, or where such methods would be too costly for the purpose.

In what follows, the method will be described for a standard three-litre BIB, but, as mentioned, the methods may be used for a number of other liquid containers and are thus not limited to relate only to boxes for wine.

The basis for the method according to the invention is the detection of the dispensing of liquid from the container using a sensor arranged on the tap which detects the opening of the tap and which via a clock, mechanically or electronically, detects the length of time the tap is open and, by knowing the outflow of liquid from different degrees of opening of the tap and remaining amount of liquid in the inner container, calculates the amount of liquid outflow and indicates the remaining liquid on a display arranged on the sensor.

The problem associated with measuring the liquid content of BIBS is that there is limited space in the container, and also the bag containing the liquid must not be damaged. Moreover, the necessary devices must be mass-producible using existing packaging machines without the automatic machines having to undergo extensive alterations. As bottling plants receive in the boxes in a flat state, the sensor must be part of the box and be equally flat and/or be a part of the actual tap.

The object of the present invention is to teach a solution in the form of a sensor capable of being mounted on existing taps which detects the dispensing of liquid and displays the remaining liquid contents on a display on the sensor.

In the following, the invention will be described in more detail with reference to the attached drawings, wherein:

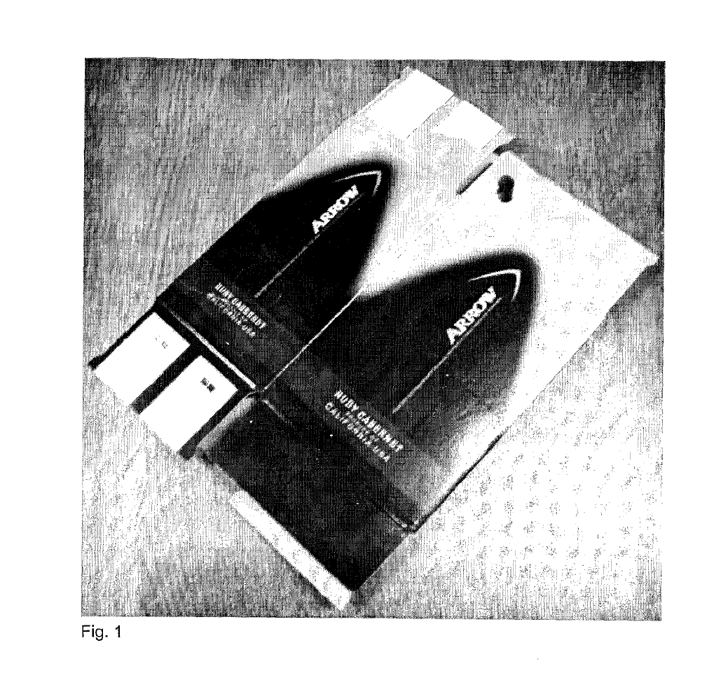

FIGS. 1-3 show an example of a wine box (Bag-in-Box—BIB).

FIG. 1 shows an example of a box as delivered to the bottling plant.

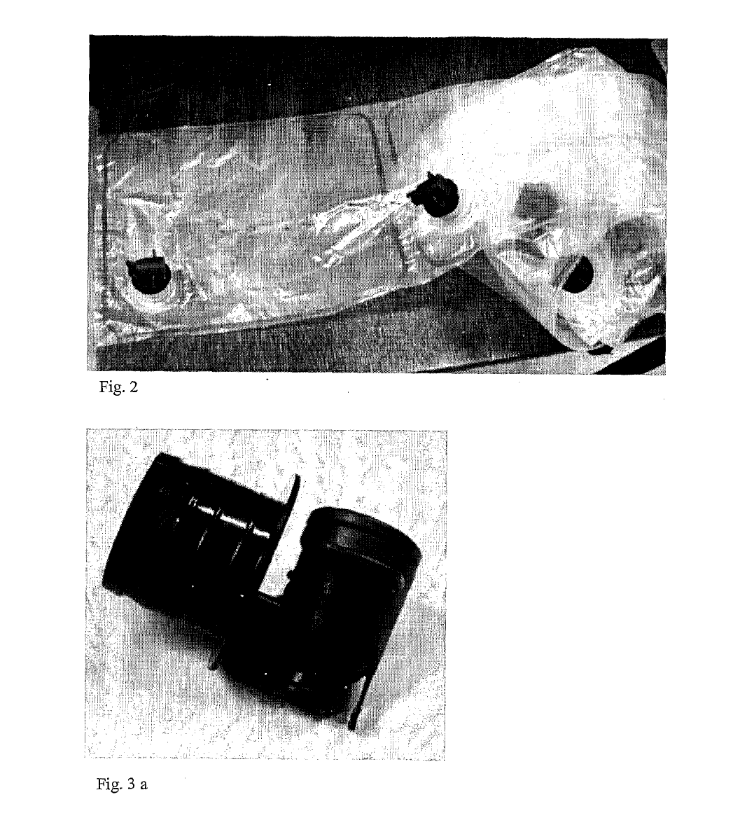

FIG. 2 shows an example of an inner container with tap as delivered to the bottling plant.

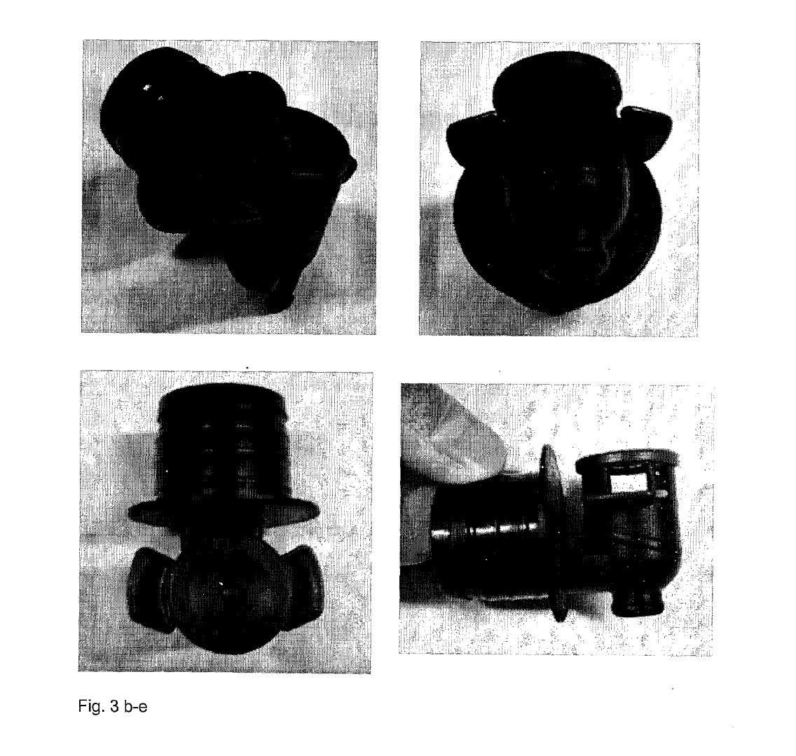

FIGS. 3a-e show an embodiment of a tap seen from different angles.

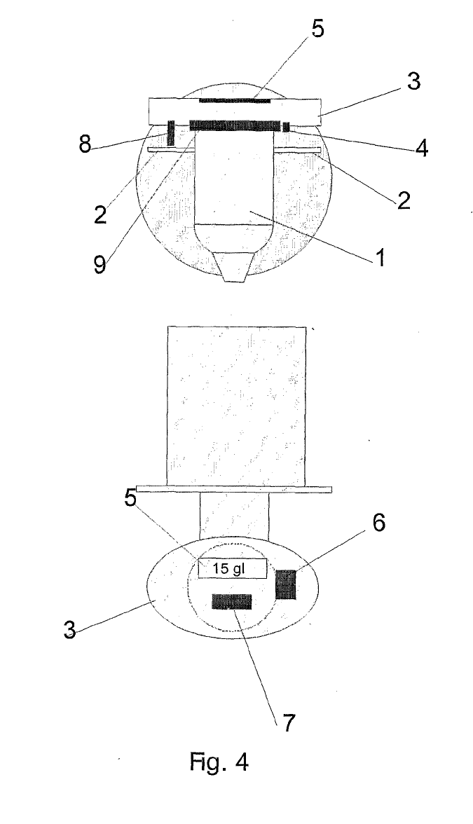

FIG. 4 shows an embodiment of the invention where the sensor is mounted on top of the tap.

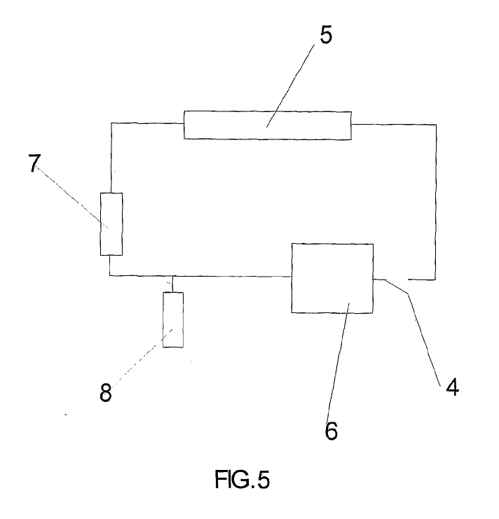

FIG. 5 is a simplified circuit diagram for the sensor.

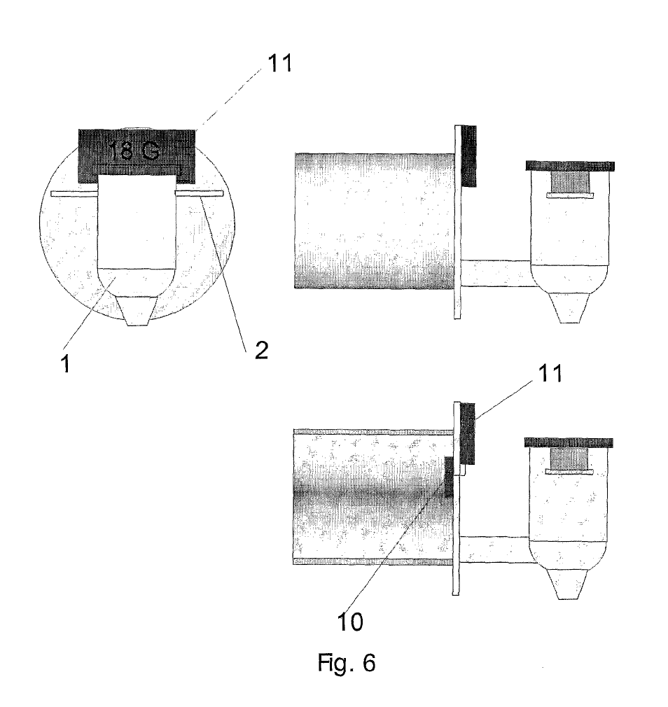

FIG. 6 shows an embodiment of the invention where a pressure and temperature sensor is mounted in the tap.

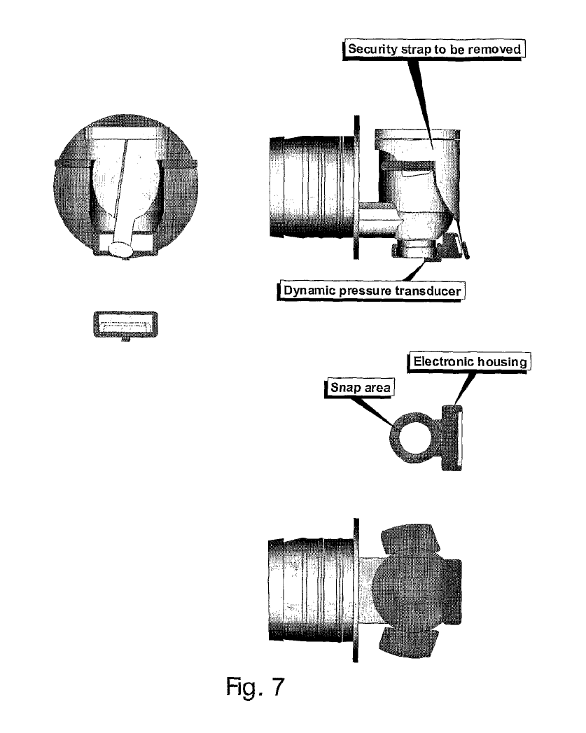

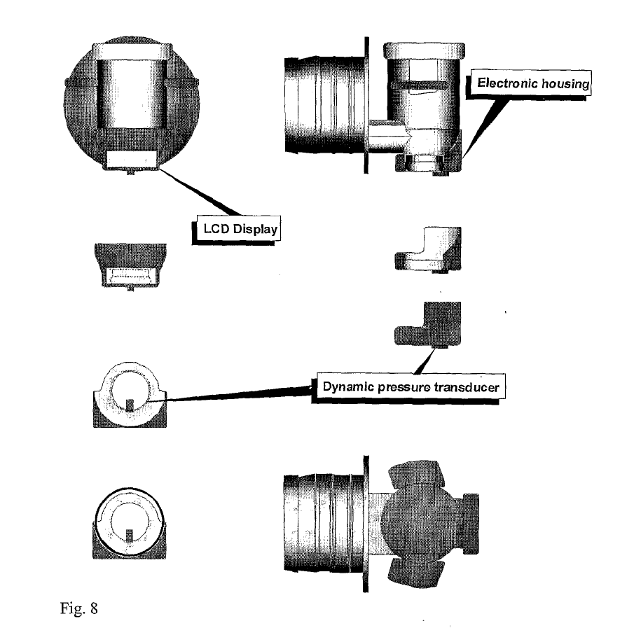

FIGS. 7 and 8 show a pressure and temperature sensor that is located in an extension of the tap.

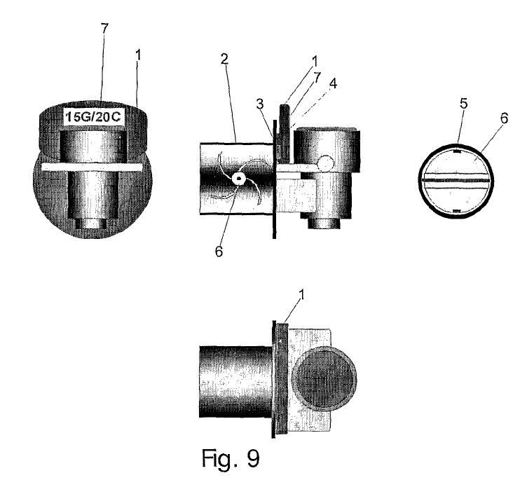

FIG. 9 shows a second embodiment in which a turbine is arranged in the tap, and where a permanent magnet is arranged on the end of each turbine tip.

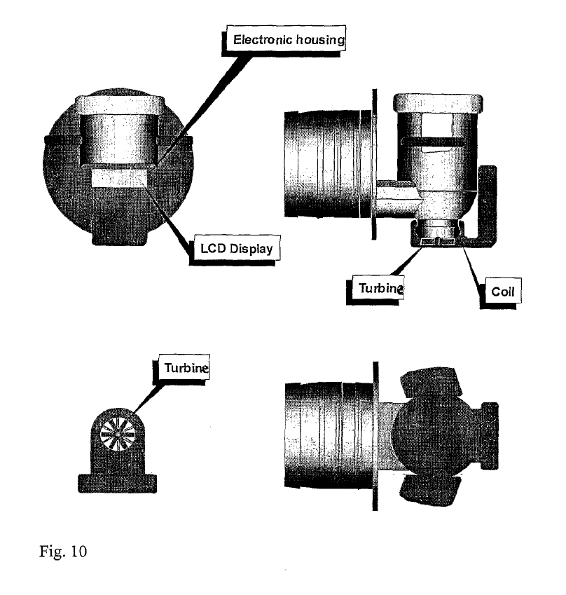

FIG. 10 shows a further embodiment where a turbine is arranged in the tap in an extension of the tap.

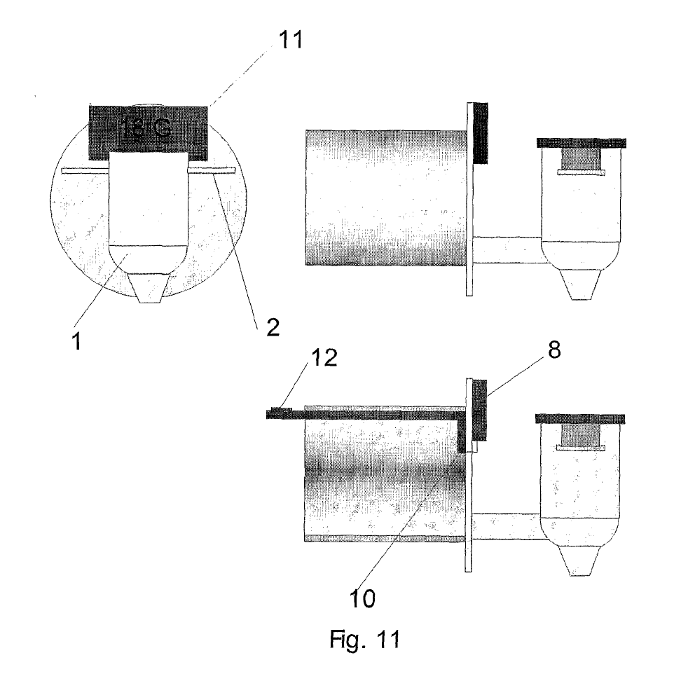

FIG. 11 shows an embodiment which comprises a piezoelectric membrane mounted on the inside of the tap.

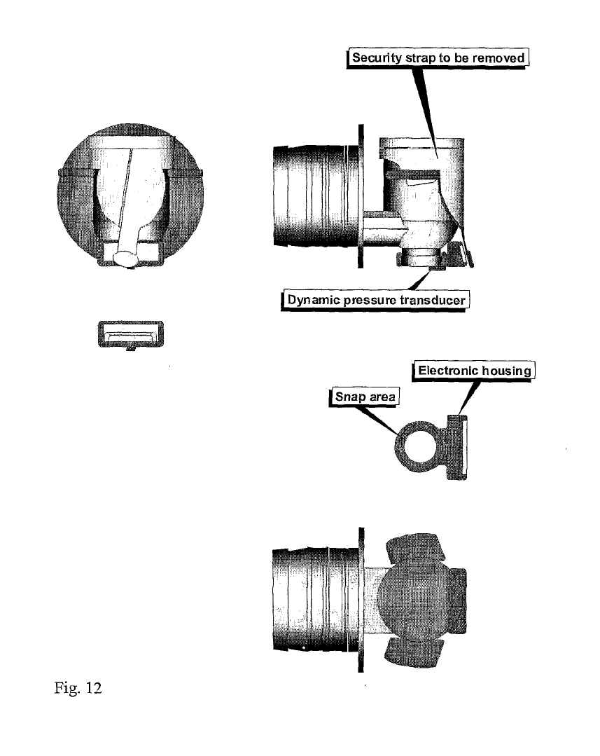

FIG. 12 shows an embodiment where a piezoelectric membrane is mounted on an extension of the tap.

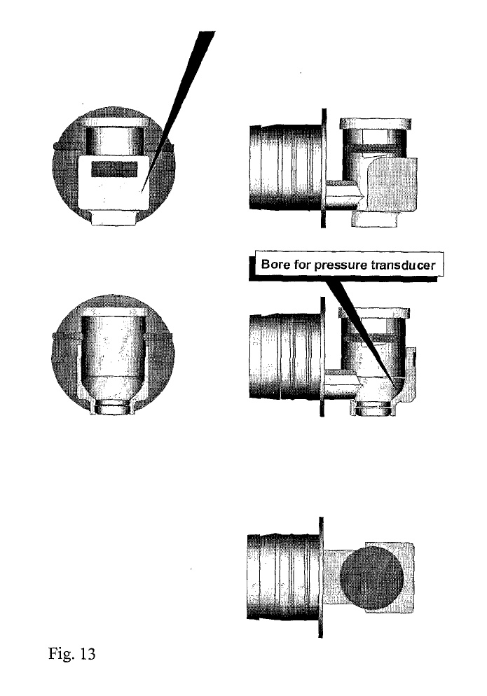

FIG. 13 shows an embodiment where the sensor is mounted in the front of the tap.

FIG. 4 shows the sensor mounted on top of the tap 1). The sensor elements are encased in a housing 3) which may have any geometric shape in order to fit the tap type in question. Arranged in the housing is a microcontroller 6) with a timer and calculating functions for calculating the amount of liquid dispensed and displaying the result on a display 5). A battery or other form of energy source 7) is arranged in the housing and is activated the first time the tap is opened by lifting the handle 2) upwards.

In addition to activating the battery, the switch 4) also starts the timer in the microcontroller.

The position of the handle is determined by a detector 8) which, in the illustrated embodiment, may be an iron rod that is pushed into a coil arranged in the housing 3).

The instrument is pre-programmed for calculation of dispensed liquid in that the amount of outflow is pre-set for different openings of the tap for different liquid contents in the container. For a full container, the outflow of liquid will be greater with the same tap opening than, for example, for a half-full container.

The housing can either be glued to the top of the existing tap and/or be equipped with a snap device where catches grip about the “lid” 9) arranged on the tap.

The temperature detector, which may be a bimetallic sensor, is arranged with the sensor pointing down towards the tap between the lid 9) and the housing 3).

FIG. 5 shows a simplified circuit diagram for the sensor where 7) is the battery, 5) is the display, 8) is the position gauge, 6) is the microcontroller with its built-in timer and algorithms and calculating functions and 4) is the switch that activates the electric is circuit.

FIG. 6 shows a sensor where in the tap there is arranged a pressure and temperature sensor 10) from which a wire is passed into the housing 11) that contains a microprocessor power source and display for displaying the results read. The microprocessor calculates the contents based on the static and dynamic pressure to which the pressure sensor is subjected when the wine is dispensed. This function makes it possible to measure the last glasses that remain in the box even though the pressure is reduced to zero when the level of the wine falls below the tap. A thermometer measures the temperature of the wine, for example, with the aid of a bimetallic sensor.

FIGS. 7 and 8 show a pressure and temperature sensor which is located in an extension of the tap. This extension can be snapped onto the end piece of the tap or fused onto it. In the same way as for the embodiment shown in FIG. 6, a microprocessor calculates the contents based on the dynamic pressure to which the pressure sensor is subjected when the wine is dispensed.

Simple standard electronic components are used for the different components.

FIG. 9 shows an embodiment of the invention wherein a turbine (6) is provided in the tap. Arranged on the tip of each turbine blade is a small permanent magnet (5). The detection of dispensed liquid is effected in that the magnetic field on the rotating turbine induces a current in a coil (3) arranged in a housing (1) together with associated electronics (4) for detecting the number of rotations of the turbine. This allows calculation of dispensed wine and the amount of wine remaining is displayed on a display (7), where also the temperature of the wine is displayed. Since the turbine generates current in the coil (3), no additional energy source is required for this embodiment of the sensor. A thermometer either is located on the inside of the tap or is an integral part of the display device. The thermometer measures the temperature, for example, with the aid of a bimetallic sensor.

The sensor is activated automatically by the first dispensing from the container and remains activated until the container is empty. The sensor has an LCD display which alternates between displaying remaining liquid in the container and its temperature. The electronics may either be provided as microelectronics or be incorporated in an ASIC (Application Specific Electronic Circuit). In the figure, the sensor is incorporated into a standard VITOP tap.

FIG. 10 shows an embodiment where in the tap there is arranged a turbine in an extension of the tap. This extension is snapped onto the end piece of the tap or is fused onto it. The display is on the outside of the extension. A permanent magnet is arranged on each turbine blade. When the turbine rotates, a current is generated in a coil which is on the outside, and the amount of current generated is a measurement of wine dispensed, which is calculated by the microprocessor. A thermometer either is located on the inside of the extension or is an integral part of the display device. The thermometer measures the temperature, for example, with the aid of a bimetallic sensor.

FIG. 11 shows an embodiment wherein a piezoelectric membrane is mounted on the inside of the tap. This membrane will move downwards in response to the pressure the wine generates. The bending of the membrane will generate a current which is proportional to the dispensing. A microprocessor equipped with a timer calculates how much wine is still in the box based on how much and for how long the membrane has moved. When the level of wine falls below the tap inlet, the microprocessor will calculate that there are several glasses left in the box. When the box is then tilted to withdraw the remaining amount of wine, a pressure will again be exerted on the piezoelectric membrane, such that it is possible to measure in a reliable manner the last glass in the container. A thermometer either is located on the inside of the tap or is incorporated into the display device.

FIG. 12 shows an embodiment wherein a piezoelectric membrane is arranged on an extension of the tap. This will move downwards when the wine is dispensed. The membrane is pressed up again when the pressure falls due to the tension in the plate analogous with a leaf spring. The bending of the plate will generate a current which is proportional to the dispensing. A microprocessor with timer calculates how much wine is still in the box based on for how long and to what extent the membrane has moved. A thermometer either is located on the inside of the extension or is incorporated into the display device.

FIG. 13 shows a solution where the sensor is mounted in the front of the tap with an integral pressure sensor which reads the pressure in the wine from a hole provided in the tap that communicates with the wine. The wine may either have direct contact with the pressure sensor or may press against an elastic membrane which in turn presses against the sensor. Like the aforementioned embodiments, this solution also has incorporated therein a temperature sensor.

In addition to what has been mentioned above, the following solutions may also be used with the tap:

1. A pressure sensor with a built-in radio sensor encased in a resilient plastic chamber. This chamber may be secured either on the inside of the wine box, under the wine bag or on the inside or outside of the wine box. The pressure variations are sent wirelessly to an instrument arranged on the box equipped with a radio receiver and microprocessor which displays the remaining liquid on a display provided on the instrument. A thermometer either is located on the inside of the plastic chamber or is incorporated into the display device. The thermometer measures the temperature, for example, with the aid of a bimetallic sensor.

2. A strain gauge that is incorporated into the tap. A microprocessor calculates the wine contents by measuring how much the strain gauge bends. A thermometer either is located on the inside of the plastic chamber or is an integral part of the display device.

3. A strain gauge that is incorporated into an extension of the tap. A microprocessor calculates the wine contents by measuring how much the strain gauge bends. A thermometer either is located on the inside of the plastic chamber or is an integral part of the display device.

The drawings show the invention used on one type of tap, but it will be appreciated that it can be used on all types of taps whether they be activated by pressure, lifting or turning. Furthermore, it should be mentioned that the illustrated locations of the sensors are solely examples as these may vary from tap type to tap type.

1. A tap for mounting on a container containing liquid, wherein said tap comprises a sensor arranged on or in the tap for determining outflow of liquid, outflow characteristics given by a pressure of liquid in the container and an opening of the tap determined by a dynamic position gauge, where an inductance of a coil is changed by insertion of an iron rod, wherein data is calculated by a microprocessor with an algorithm and the data are displayed on a display provided on the sensor.

2. The tap according to claim 1, wherein the dynamic position gauge indicates a degree of opening of the tap and its value is sent to the microprocessor for calculating an amount of liquid outflow in accordance with the opening and liquid level in the container, which is a measure of the pressure of the liquid against the tap, which in turn determines a degree of outflow at different opening degrees of the tap.

3. A method for detecting liquid level in a container equipped with a tap, according to claim 1 comprising:
detecting contents of the container by the sensor arranged on the tap;
calculating outflow of liquid as a function of dispensing time and outflow characteristics for full or partial opening of the tap, wherein a housing that accommodates the sensor in said tap comprises a display which displays measured values, a power source, a dynamic position gauge and a microprocessor equipped with a timer, algorithms and a calculating program for calculating an amount of liquid dispensed; and
displaying the remaining liquid on the display.

4. The method for detecting the liquid level in a container in accordance with claim 3, wherein, in the sensor, there is arranged a dynamic position gauge which indicates how much the tap has been opened and wherein values are sent to the microprocessor for calculation of outflow according to the opening and the liquid level in the container at the time of measurement.

5. A method of detecting liquid level in a medicine container, comprising:
mounting a tap according to claim 1 on the medicine container, and
detecting liquid level in the medicine container by detecting the data displayed on the display.

6. A method of detecting liquid level in a chemicals container, comprising:
mounting a tap according to claim 1 on the chemicals container, and
detecting liquid level in the chemicals container by detecting the data displayed on the display.

7-10. (canceled)

11. The tap of claim 1, wherein the sensor comprises a temperature sensor that reads temperature of the liquid.
